(19) United States
(12) Patent Application Publication
(10) Pub. No.: US 2011/0247590 A1
(43) Pub. Date: Oct. 13, 2011

(54) INJECTORS UTILIZING LATTICE SUPPORT STRUCTURE

(75) Inventor: Matthew Raymond Donovan, Ankeny, IA (US)

(73) Assignee: Delavan Inc, West Des Moines, IA (US)

(21) Appl. No.: 12/755,705

(22) Filed: Apr. 7, 2010

(51) Int. Cl. F02M 61/14; B23P 15/00

(52) U.S. Cl. 123/470; 29/890.142

(57) ABSTRACT

A fuel injector for a gas turbine engine includes an inlet having a fuel inlet fitting for receiving fuel. A feed arm is mounted to the inlet and has an internal conduit in fluid communication with the inlet for conveying fuel from the inlet fitting through the feed arm. A nozzle body is operatively connected to the feed arm for injecting fuel from the internal conduit into a combustor of a gas turbine engine. At least one of the inlet, feed arm, and nozzle body includes a lattice support structure.

### BACKGROUND OF THE INVENTION

1. Field of the Invention

The present invention relates to injectors and atomizers, and more particularly to support structures of injectors and atomizers for gas turbine engines.

2. Description of Related Art

A variety of devices are known in the art for injection and atomization of liquids. One exemplary application for such devices is in fuel injection for gas turbine engines. Typical fuel injectors include an inlet fitting where fuel is introduced into the injector from a fuel line or manifold. Many fuel injectors include a feed arm structure extending from the inlet fitting to a nozzle body, where fuel is issued from the injector into a combustor, typically as an atomized spray.

Known injector designs typically rely on some form of metallic conduit or tube to deliver fuel from a supply manifold to a nozzle body or atomizing tip. For strength, thermal management, and aerodynamic purposes, fuel tubes are typically brazed or welded to larger supporting structures such as a feed arm and inlet fitting. A wide variety of configurations are known, including injectors with multiple fuel circuits, multiple air blast circuits, heat shielding, and the like. One example is the pure air blast fuel injector described in U.S. Patent Application Publication No. 2009/0277176 to Caples, which is incorporated by reference herein in its entirety.

Known injectors are constructed of solid components that are machined either from casting, forging, wrought bar stock, or the like. Fuel injectors for gas turbine engines, for example, require material properties that will have impact resistance and/or robustness and be able to withstand the harsh temperature, pressure, and chemical conditions present within gas turbine engines. Superalloys typically used for withstanding such conditions are difficult to machine. The components are almost always constructed with solid walls to provide strength and rigidity for maintaining the structural integrity of the component in a high temperature, high pressure environment.

The state of the art devices produced from cast, forged, or wrought products are generally limited to shapes and sizes that can be machined or generated through traditional subtractive manufacturing methods. The limitations involved in subtractive machining generally leave more material in a given component than is actually necessary to supply the requisite strength or material properties. As a result, typical parts are geometry-limited and are substantially heavier than desired. For example, in typical feed arms for fuel injectors, a forged part is machined down to its final dimensions using subtractive machining. But due to the limitations of the subtractive machining processes, some material is left behind that is not needed, structurally or otherwise, simply because the material cannot be reached for removal by conventional processes without removing other structures that are necessary. Known parts utilizing cast trusses, wire pads, metallic foams, and the like for weight reduction suffer substantially from randomness in the structures and related analytical difficulties, and/or size and geometry limitations as in cast components.

The conventional methods and systems have generally been considered satisfactory for their intended purpose. However, there is still a need in the art for injectors and injector components having improved geometrical intricacy and reduced weight. There also remains a need in the art for such injectors and components that are economically viable. The present invention provides a solution for these problems.

### SUMMARY OF THE INVENTION

The subject invention is directed to a new and useful fuel injector for a gas turbine engine. The fuel injector includes an inlet having a fuel inlet fitting for receiving fuel. A feed arm is mounted to the inlet and has an internal conduit in fluid communication with the inlet for conveying fuel from the inlet fitting through the feed arm. A nozzle body is operatively connected to the feed arm for injecting fuel from the internal conduit into a combustor of a gas turbine engine. At least one of the inlet, feed arm, and nozzle body includes a lattice support structure.

In certain embodiments, the lattice support structure is a mostly hollow lattice structure. The lattice support structure can include a material suitable for processing by direct metal laser sintering, selective laser sintering, electron beam melting, and/or any other suitable additive fabrication process.

In accordance with certain embodiments, the lattice support structure can be surrounded at least in part by an exterior heat shield for thermally isolating the internal conduit from external conditions. The exterior heat shield can be integral with the lattice support structure, as can the internal conduit. The lattice support structure can be included at least in part in the feed aim. It is also contemplated that the feed arm can include an integral mounting flange, and that the mounting flange and feed arm can each include a portion of the lattice support structure.

In another aspect of the invention, a matrix can fill in at least a portion of the lattice support structure such that the matrix and lattice support structure are a composite structure. The matrix can be a high temperature resin matrix filling.

The invention also provides a feed arm for a fuel injector. The feed arm includes a fuel circuit having an inlet in fluid communication with an internal conduit having an outlet for passage of fuel from the inlet through the internal conduit. A lattice support structure substantially surrounds the internal conduit. A heat shield substantially surrounds the lattice support structure to thermally isolate the fuel circuit from exterior conditions.

The invention also provides a method of forming a fuel injector for a gas turbine engine. The method includes forming a feed arm having an internal conduit substantially surrounded by a lattice support structure. At least one of the lattice support structure and internal conduit can be formed by an additive fabrication process.

In accordance with certain embodiments, the step of forming a feed arm includes forming an exterior heat shield substantially surrounding the lattice support structure. The internal conduit, lattice support structure, and exterior heat shield can all be formed integrally with one another by an additive fabrication process. The step of farming a feed arm can include forming a mounting flange integral with the feed arm, wherein the mounting flange includes a portion of the lattice support structure. The method can include filling in at least a portion of the lattice support structure with a matrix material to form a composite structure.

These and other features of the systems and methods of the subject invention will become more readily apparent to those skilled in the art from the following detailed description of the preferred embodiments taken in conjunction with the drawings.

### BRIEF DESCRIPTION OF THE DRAWINGS

So that those skilled in the art to which the subject invention appertains will readily understand how to make and use the devices and methods of the subject invention without undue experimentation, preferred embodiments thereof will be described in detail herein below with reference to certain figures, wherein:

FIG. 1 is a perspective view of an exemplary embodiment of a fuel injector support constructed in accordance with the present invention, showing the inlet fitting, feed arm, and nozzle body portion;

FIG. 2 is a cross-sectional side elevation view of the fuel injector support structure of FIG. 1, showing the lattice support structure in the feed arm and inlet fitting portions;

FIG. 3 is a cross-sectional side elevation view of the lattice support structure of FIG. 2, showing an enlarged section of the feed arm portion;

FIG. 4 is a side elevation view of a portion of the fuel injector support structure of FIG. 1, showing the fuel injector support structure partially constructed by an additive fabrication process;

FIG. 5 is a cross-sectional plan view of a portion of the fuel injector support structure of FIG. 4, showing a thin slice of the base of the feed arm portion constructed by an additive fabrication process;

FIG. 6 is a side elevation view of a portion of the fuel injector support structure of FIG. 4, showing the fuel injector support structure partially constructed to a greater extent than shown in FIG. 4;

FIG. 7 is a cross-sectional plan view of a portion of the fuel injector support structure of FIG. 6, showing a thin slice of the feed arm portion constructed by an additive fabrication process;

FIG. 8 is a side elevation view of the fuel injector support structure of FIG. 1, showing the fuel injector support structure after completed construction thereof;

FIG. 9 is a cross-sectional view of a portion of the fuel injector support structure of FIG. 8, showing the lattice support structure in the inlet fitting portion indicated in FIG. 8;

FIG. 10 is a perspective view of another exemplary embodiment of a fuel injector support structure constructed in accordance with the present invention, showing a lattice support structure for supporting a conduit;

FIG. 11 is a perspective view of the fuel injector support structure of FIG. 10, showing the conduit in place with a matrix material filling in the cells of the lattice support structure to form a composite structure; and

FIG. 12 is a perspective view of another exemplary embodiment of a fuel injector support structure constructed in accordance with the present invention, showing a structure that includes an integral mounting flange that is latticed for weight reduction.

### DETAILED DESCRIPTION OF THE PREFERRED EMBODIMENTS

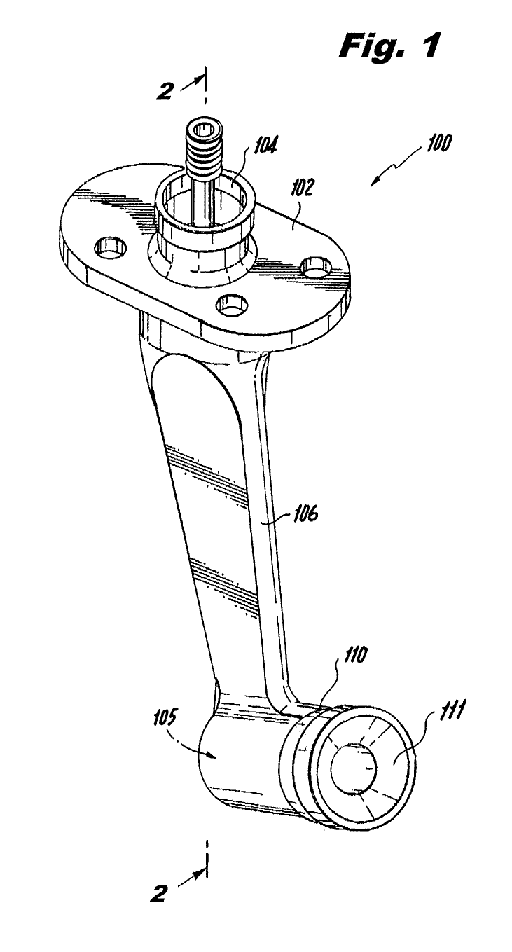

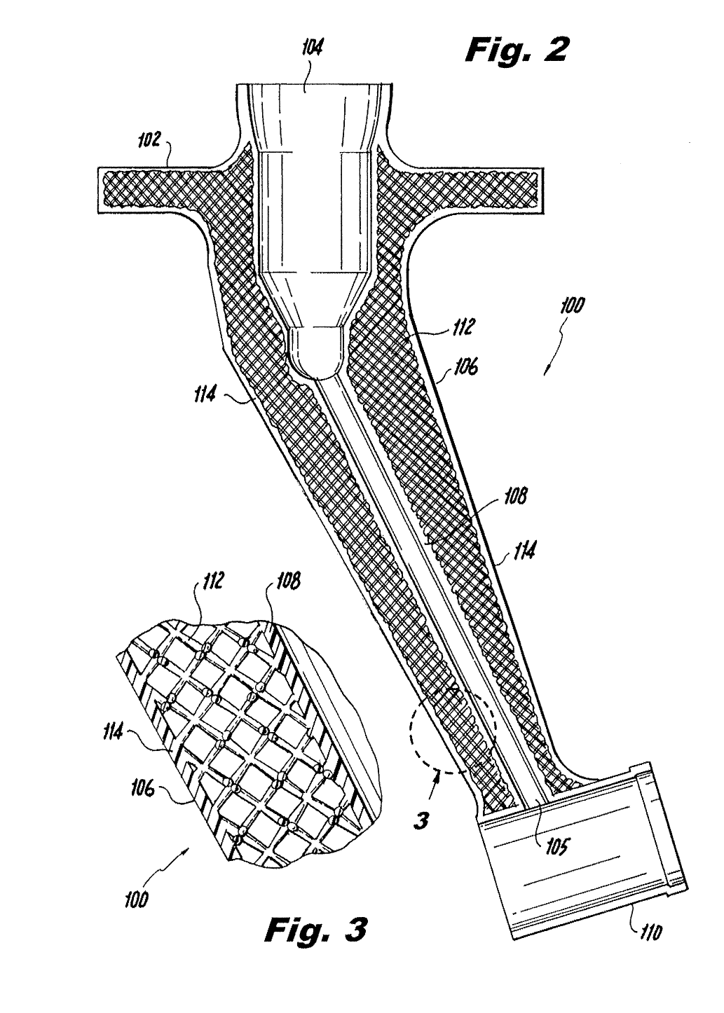

Reference will now be made to the drawings wherein like reference numerals identify similar structural features or aspects of the subject invention. For purposes of explanation and illustration, and not limitation, a partial view of an exemplary embodiment of a fuel injector in accordance with the invention is shown in FIG. 1 and is designated generally by reference character 100. Other embodiments of fuel injectors in accordance with the invention, or aspects thereof, are provided in FIGS. 2-12, as will be described. The methods and systems of the invention can be used to increase structural intricacy and to reduce weight in injectors and injector components.

Referring now to FIG. 1, fuel injector 100 for a gas turbine engine is shown, including a mounting flange 102 having a fuel inlet 104 with an inlet fitting for receiving fuel. A feed arm 106 is mounted to mounting flange 102 and has an internal conduit 108 (see FIG. 2) in fluid communication with fuel inlet 104 for conveying fuel through feed arm 106. Mounting flange 102 is formed integral with feed arm 106, however it could optionally be made separately and joined to feed arm 106. A nozzle body 110 is operatively connected to feed arm 100 for receiving any suitable nozzle or atomizer components 111 for injecting fuel from internal conduit 108 into a combustor of a gas turbine engine. Feed arm 106 defines a fuel circuit running from mounting flange 102, through internal conduit 108, and to an outlet 105 for passage of fuel into nozzle body 110.

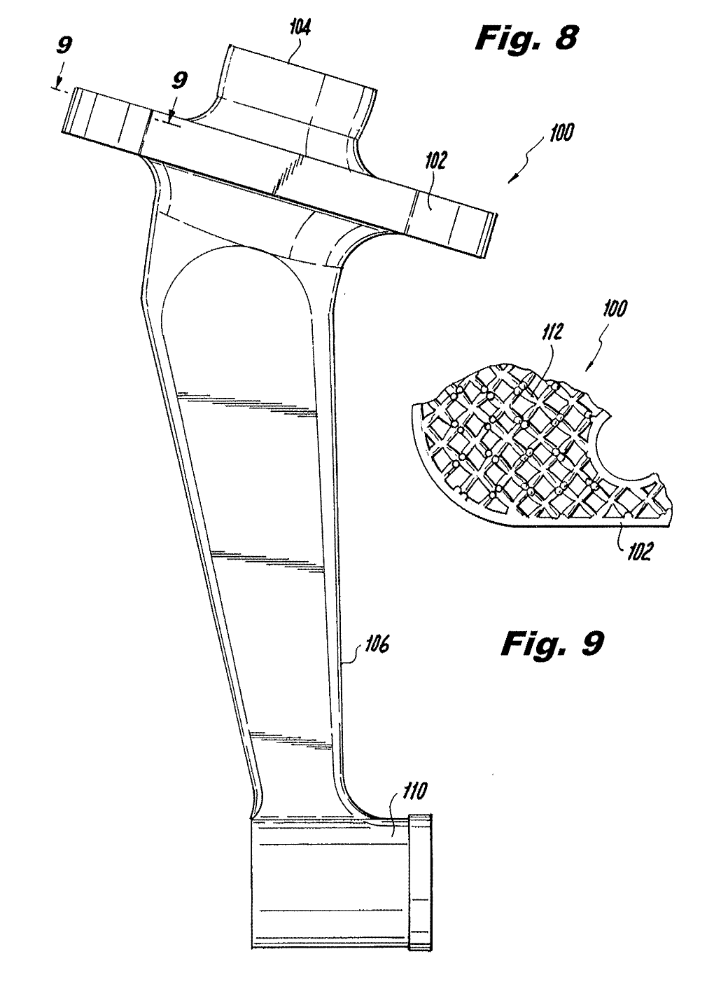

With reference now to FIG. 2, which shows injector 100 with atomizer components 111 removed, a lattice support structure 112 supports internal conduit 108 within feed arm 106. Lattice support structure 112 runs continuously throughout portions of mounting flange 102 and feed arm 106. As indicated in the enlarged view of FIG. 3, lattice support structure 112 is a hollow core lattice structure that is mostly hollow with generally cubic cells defined by an intersecting grid of lattice members. FIG. 9 shows another enlarged portion of lattice structure 112, which is in the mounting flange 102, as indicated in FIG. 8. This structure provides injector 100 with structural and thermal properties comparable to traditional injectors, but with comparatively less material and weight.

Lattice support structure 112 is constructed by one or more additive fabrication processes, as will be described in further detail below. It therefore provides a greater degree of geometrical intricacy than would be possible by typical subtractive machining Additive fabrication processes can produce lattice structures with trusses generally about 0.010 inches to about 0.100 inches in cross section, for example.

As a result, injector 100 has sufficient strength and thermal resistance, but has only about half of the weight that it would have if produced from solid stock by typical subtractive machining. For example, if the structures shown in FIGS. 1-3 were fabricated using traditional subtractive machining (i.e., with no lattice structure), the volume would be about 3.282 cubic inches and the weight would be about 0.985 pounds if an aerospace grade nickel based alloy were used. However, fuel injector 100 having lattice support structure 112 has a volume of only 1.407 cubic inches (not counting the voids in lattice structure 112) and a weight of about 0.422 pounds. There is thus approximately 57% savings in weight.

Those skilled in the art will readily appreciate that the lattice structures described herein are exemplary only, and that any suitable lattice structure geometry or truss size can be used without departing from the spirit and scope of the invention. Lattice structures can be tailored or designed for specific applications to meet impact resistance/robustness, vibration, static loading, and/or thermal management requirements, such as to reduce coking in fuel circuits, as needed. The lattice support structure can be a highly defined, precisely engineered lattice structure tailored to for specific applications, and can include cells that are cubic, triangular, tetrahedral, elliptical, or any other suitable shape or combination of shapes as needed for a given application without departing from the spirit and scope of the invention.

An exemplary design and manufacturing process for fuel injectors such as injector 100 can begin with a CAD or 3D model of the basic part geometry. The CAD or 3D model can be used to design the lattice support structure using Finite Element Analysis (FEA) software, such as ANSYS software available from Ansys, Inc. of Canonsburg, Pa. Another exemplary software package for this design step is Magics e-Solution Suite from Materialise NV of Leuven, Belgium. The FEA model, including the lattice structure, can be used to control the additive fabrication hardware to produce the part. An example of suitable additive fabrication hardware is an EOS systems M270 DMLS machine, available from EOS GmbH of Munich, Germany.

With continued reference to FIGS. 2-3, lattice support structure 112 is substantially surrounded on the exterior portion by an exterior heat shield 114 for thermally isolating internal conduit 108 from external conditions. Exterior heat shield 114 is integral with lattice support structure 112, as is internal conduit 108. Lattice support structure 112 is continuous throughout feed atm 106 and mounting flange 102. Optionally, exterior heat shield 114 and/or internal conduit 108 can be fabricated separate from lattice support structure 112 and can be added to injector 100 by any suitable joining method.

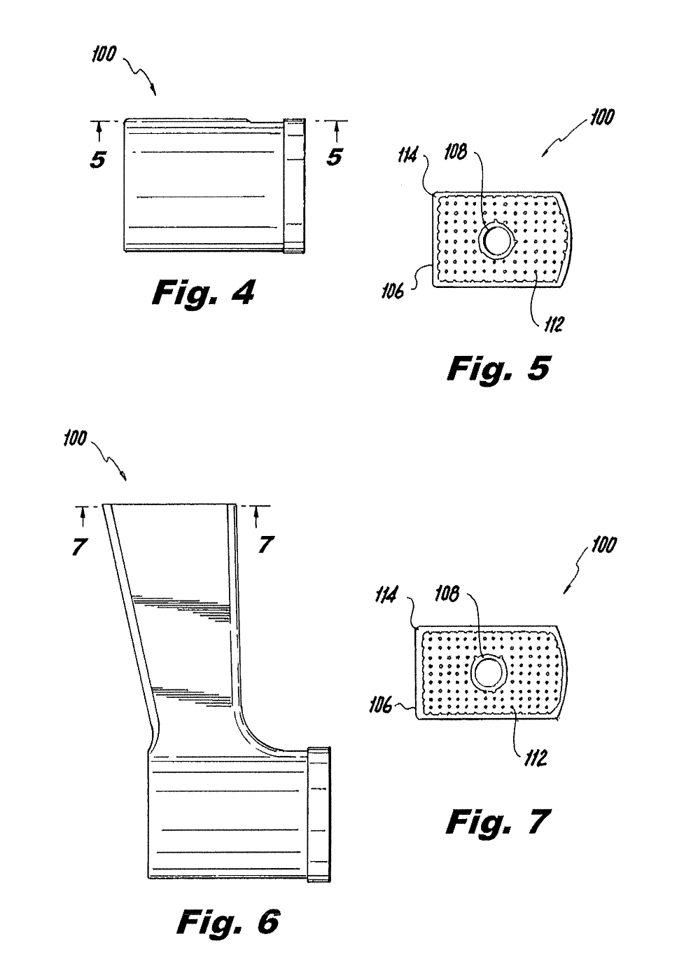

Referring now to FIGS. 4-8, the invention also provides a method of forming fuel injectors and/or injector components, such as feed arm 106 and fuel injector 100. The method includes forming a feed arm, e.g., feed arm 106, having an internal conduit, e.g., internal conduit 108, substantially surrounded by a lattice support structure, e.g., lattice support structure 112. The lattice support structure, internal conduit, and external heat shield, e.g., external heat shield 114, are formed integrally by any suitable additive fabrication process. Suitable additive fabrication processes include direct metal laser sintering, selective laser sintering, electron beam melting, and/or any other suitable additive fabrication process. Suitable materials for forming a feed arm in this manner include aerospace grade alloys such as Inconel® 625, Inconel® 718, Hastelloy® X, Titanium, or any other suitable material (Inconel® alloys are available from Special Metals Corporation of New Hartford, N.Y. and Hastelloy® alloys are available from Haynes International Inc. of Kokomo, Ind.). Additive fabrication allows the injector geometry to be “grown” with virtually any lattice structure specified, starting from any suitable point of the structure. For example, FIG. 4 shows injector 100 being constructed starting from the bottom of the nozzle body, growing the part upward toward inlet 104. At the stage shown in FIG. 4, the nozzle body is complete and the lowest portion of the feed arm has been formed. FIG. 5 shows the cross-sectional slice at which the process in FIG. 4 has reached. FIG. 6 shows a later point in the fabrication, where feed arm 106 is roughly half completed. FIG. 7 shows the corresponding cross-sectional slice for the stage of FIG. 6.

It can be noted that some additive fabrication processes, such as sintering, use powder which if not sintered remains in the power form. In order to avoid trapping non-sintered power in the lattice structure, small holes can be left in the part, e.g., in the external heat shield, through which the powder can be evacuated. The holes can then be plugged once the powder is removed.

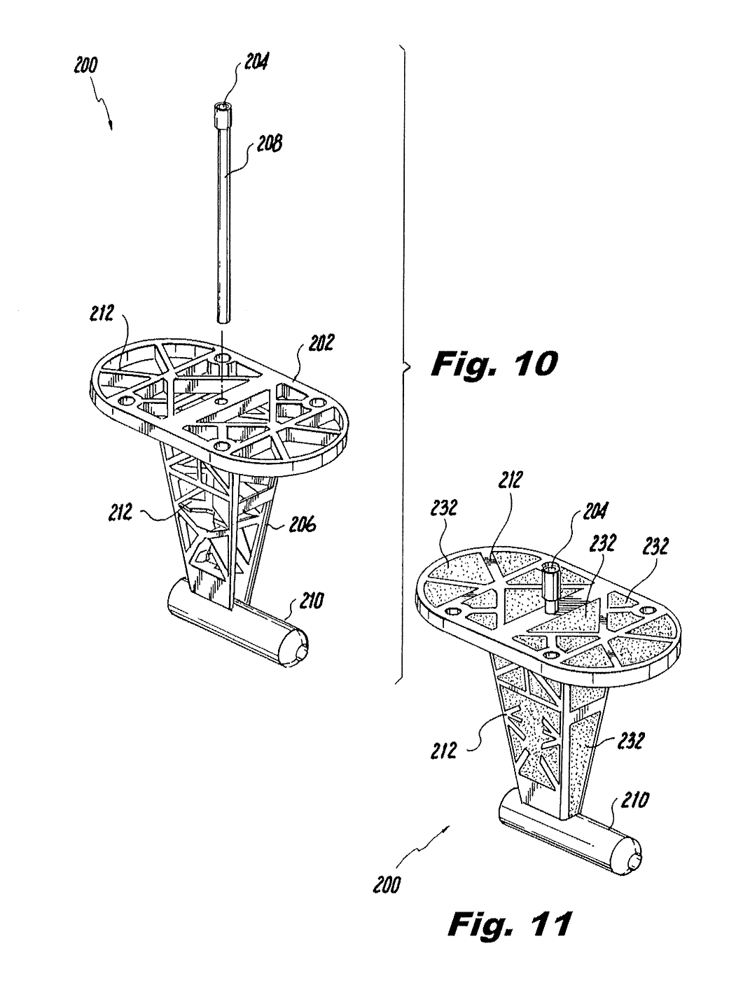

With reference now to FIGS. 10-11, another exemplary embodiment of a fuel injector 200 is shown. Injector 200 includes an internal conduit 208 with an inlet 204 initially formed separate from feed arm 206, mounting flange 202, and nozzle body 210. When internal conduit 208 is mounted in place, it is supported by lattice support structure 212. Lattice support structure 212 can optionally be filled in with a matrix material 232 to form a composite structure as shown in FIG. 11. An external heat shield, such as external heat shield 114, is optional, as the matrix material can be a high-temperature resin matrix, or any other suitable matrix material, to provide thermal isolation to internal conduit 208. Injector 200 can be formed by essentially the same process as described above with respect to fuel injector 100. The main differences in the two processes are the separate formation and mounting of internal conduit 208, and filling in at least a portion of the lattice support structure 212 with a matrix material to form a composite structure.

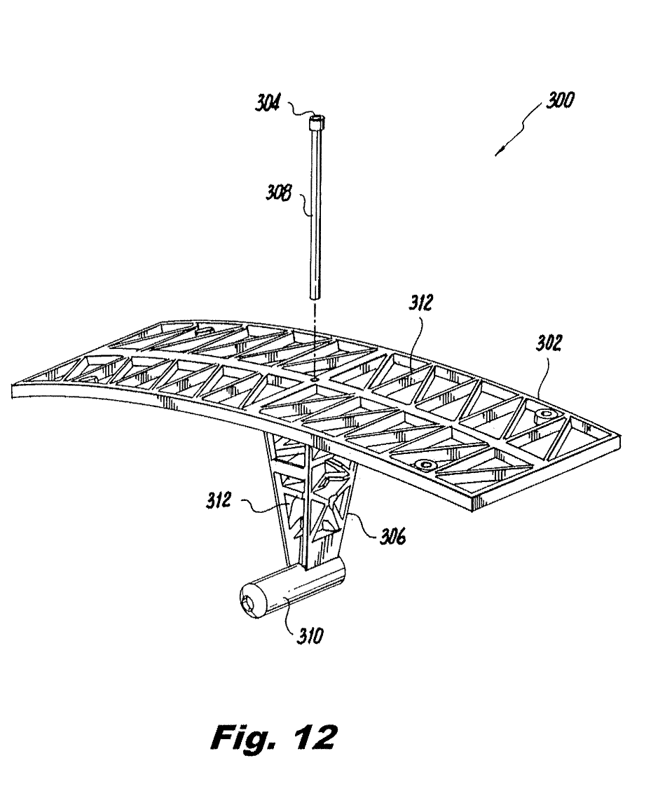

Referring now to FIG. 12, another exemplary embodiment of a fuel injector support structure 300 is shown having an integral, laterally extending mounting flange 302 that is latticed for weight reduction. Support structure 300 includes inlet 304, feed arm 306, internal conduit 308, and nozzle body 310 substantially as described above with reference to FIGS. 10-11. The lattice structure 312 of flange 302 can be precisely tailored for structural considerations as described above. Flange 302 can readily be adapted to be used as a fuel delivery manifold, and/or can be filled with a ceramic or CMC matrix resin to provide thermal dampening or dissipation.

While the injectors and components described above have been provided in the exemplary context of fuel injectors for gas turbine engines, those skilled in the art will readily appreciate that other injector types or injector components can be similarly improved without departing from the spirit and scope of the invention. Moreover, those skilled in the art will readily appreciate that the particular injector geometries described herein are exemplary only, and that other fuel injector configurations can be used without departing from the spirit and scope of the invention.

The methods and systems of the present invention, as described above and shown in the drawings, provide for injectors and injector components with superior properties including improved geometrical intricacy and lower weight. While the apparatus and methods of the subject invention have been shown and described with reference to preferred embodiments, those skilled in the art will readily appreciate that changes and/or modifications may be made thereto without departing from the spirit and scope of the subject invention.

What is claimed is:

1. A fuel injector for a gas turbine engine comprising:
a) an inlet having a fuel inlet fitting for receiving fuel;
b) a feed arm mounted to the inlet and having an internal conduit in fluid communication with the inlet for conveying fuel from the inlet fitting through the feed arm; and
c) a nozzle body operatively connected to the feed atm for injecting fuel from the internal conduit into a combustor of a gas turbine engine, wherein at least one of the inlet, feed arm, and nozzle body includes a lattice support structure.

2. A fuel injector as recited in claim 1, wherein the lattice support structure is a mostly hollow lattice structure.

3. A fuel injector as recited in claim 1, wherein the lattice support structure includes a material suitable for processing by at least one process selected from the group consisting of direct metal laser sintering, selective laser sintering, and electron beam melting.

4. A fuel injector as recited in claim 1, wherein the lattice support structure is surrounded at least in part by an exterior heat shield for thermally isolating the internal conduit from external conditions.

5. A fuel injector as recited in claim 1, wherein the lattice support structure is included at least in part in the feed arm, wherein the feed arm includes an exterior heat shield integral with the lattice support structure, and wherein the internal conduit is integral with the lattice support structure.

6. A fuel injector as recited in claim 1, wherein the feed arm includes an integral mounting flange, and wherein the mounting flange and feed arm each include a portion of the lattice support structure.

7. A fuel injector as recited in claim 1, further comprising a matrix filling in at least a portion of the lattice support structure such that the matrix and lattice support structure are a composite structure.

8. A fuel injector as recited in claim 1, further comprising a high temperature resin matrix filling in at least a portion of the lattice support structure such that the matrix and lattice support structure are a composite structure.

9. A feed arm for a fuel injector comprising:
a) a fuel circuit including an inlet in fluid communication with an internal conduit having an outlet for passage of fuel from the inlet through the internal conduit;
b) a lattice support structure substantially surrounding the internal conduit; and
c) a heat shield substantially surrounding the lattice support structure to thermally isolate the fuel circuit from exterior conditions.

10. A fuel injector as recited in claim 9, wherein the lattice support structure is a mostly hollow lattice structure.

11. A fuel injector as recited in claim 9, wherein the lattice support structure includes a material suitable for processing by at least one process selected from the group consisting of direct metal laser sintering, selective laser sintering, and electron beam melting.

12. A fuel injector as recited in claim 9, wherein the heat shield is integral with the lattice support structure.

13. A fuel injector as recited in claim 9, wherein the lattice support structure, internal conduit, and heat shield, are all integral with one another.

14. A fuel injector as recited in claim 9, further comprising a matrix filling in at least a portion of the lattice support structure such that the matrix and lattice support structure are a composite structure.

15. A fuel injector as recited in claim 9, further comprising a high temperature resin matrix filling in at least a portion of the lattice support structure such that the matrix and lattice support structure are a composite structure.

16. A method of forming a fuel injector for a gas turbine engine comprising:
a) forming a feed arm having an internal conduit substantially surrounded by a lattice support structure.

17. A method as recited in claim 16, wherein at least one of the lattice support structure and internal conduit is formed by an additive fabrication process.

18. A method as recited in claim 16, wherein the step of forming a feed arm includes forming an exterior heat shield substantially surrounding the lattice support structure, wherein the internal conduit, lattice support structure, and exterior heat shield are all formed integrally with one another by an additive fabrication process.

19. A method as recited in claim 16, wherein the step of forming a feed arm includes forming a mounting flange integral with the feed arm, wherein the mounting flange includes a portion of the lattice support structure.

20. A method as recited in claim 16, further comprising filling in at least a portion of the lattice support structure with a matrix material to form a composite structure.
